(19) United States
(12) Patent Application Publication
(10) Pub. No.: US 2026/0039182 A1
(43) Pub. Date: Feb. 5, 2026

(54) POWER CONVERTER

(71) Applicant: LITE-ON TECHNOLOGY CORPORATION, TAIPEI CITY (TW)

(72) Inventors: Cheng-Wei TSENG, Taipei City (TW); Han-Min HUANG, Taipei City (TW); Kai-De CHEN, Taipei City (TW); Yong-Long SYU, Taipei City (TW); Chen CHEN, Taipei City (TW)

(21) Appl. No.: 19/184,042

(22) Filed: Apr. 21, 2025

Related U.S. Application Data
(60) Provisional application No. 63/679,326, filed on Aug. 5, 2024.

(51) Int. Cl. H02M 1/00; H02M 3/00; H02M 3/335

(52) U.S. Cl. CPC H02M 1/0054; H02M 1/0083; H02M 3/003; H02M 3/01; H02M 3/33573; H02M 3/33576

(57) ABSTRACT

A power converter includes an input circuit, a transformer circuit, and an output circuit. The input circuit has a first contact point, a second contact point, a third contact point, and a fourth contact point. The transformer circuit has a primary winding and a first secondary winding. The primary winding has a first contact point and a second contact point. The first secondary winding has a first contact point and a second contact point. The first contact point and the second contact point of the primary winding are coupled to the first contact point and the second contact point of the input circuit. The first contact point and the second contact point of the first secondary winding are coupled to the third contact point and the fourth contact point of the input circuit. The output circuit is coupled to the second contact point of the first secondary winding.

### CROSS REFERENCE TO RELATED APPLICATIONS

This application claims priority of U.S. Provisional Application No. 63/679,326, filed Aug. 5, 2024, the entirety of which is incorporated by reference herein.

### BACKGROUND OF THE INVENTION

### Field of the Invention

An embodiment of the present invention relates to a converter, and in particular it relates to a power converter.

### Description of the Related Art

FIG. 1 is a schematic view of a power converter of the prior art. Please refer to FIG. 1. The power converter 100 includes a transistor Q1, a diode DR1, a capacitor CR1, a transistor Q2, a diode DR2, a capacitor CR2, a transistor Q3, a diode DR3, a capacitor CR3, a transistor Q4, a diode DR4, a capacitor CR4, an inductor Lr, an inductor Lm, a capacitor Cr, a transformer TR1, a diode DO1, a diode DO2, a capacitor Cf and a resistor Rf. The connection relationship of the transistor Q1, the diode DR1, the capacitor CR1, the transistor Q2, the diode DR2, the capacitor CR2, the transistor Q3, the diode DR3, the capacitor CR3, the transistor Q4, the transistor DR4, the capacitor CR4, the inductor Lr, the inductor Lm, the capacitor Cr, the transformer TR1, the diode DO1, the diode DO2, the capacitor Cf and the resistor Rf is shown in FIG. 1, and the description thereof is not repeated herein.

However, the power converter 100 is a symmetrical power converter, and its switch withstand voltage (such as the withstand voltages of the transistor Q1, the transistor Q2, the transistor Q3 and the transistor Q4) is relatively high, and its cost is also relatively high. In addition, if the voltage conversion ratio of the power converter 100 is higher, the number of turns in the winding of the transformer TR1 may be greater, so the loss of the copper wire of the transformer TR1 may also be higher. Therefore, a new design is needed to solve the problem described above.

### BRIEF SUMMARY OF THE INVENTION

An embodiment of the present invention provides a power converter, thereby reducing the switch withstand voltage and switch cost of the input circuit, and reducing the circuit loss and increasing the circuit conversion efficiency, so as to enhance the effect of energy saving and carbon reduction.

An embodiment of the present invention provides a power converter, which includes an input circuit, a transformer circuit, and an output circuit. The input circuit has a first contact point, a second contact point, a third contact point, and a fourth contact point. The transformer circuit has a primary winding and a first secondary winding. The primary winding has a first contact point and a second contact point. The first secondary winding has a first contact point and a second contact point. The first contact point of the primary winding is coupled to the first contact point of the input circuit. The second contact point of the primary winding is coupled to the second contact point of the input circuit. The first contact point of the first secondary winding is coupled to the third contact point of the input circuit. The second contact point of the first secondary winding is coupled to the fourth contact point of the input circuit. The output circuit is coupled to the second contact point of the first secondary winding.

According to the power converter disclosed by the embodiment of the present invention, the first contact point of the primary winding of the transformer circuit is coupled to the first contact point of the input circuit, the second contact point of the primary winding of the transformer circuit is coupled to the second contact point of the input circuit, the first contact point of the first secondary winding of the transformer circuit is coupled to the third contact point of the input circuit, and the second contact point of the first secondary winding of the transformer circuit is coupled to the fourth contact point of the input circuit. The output circuit is coupled to the second contact point of the first secondary winding. Therefore, the switch withstand voltage and switch cost of the input circuit may be effectively reduced, and the circuit loss may be reduced and the circuit conversion efficiency may be increased, so as to save energy.

### BRIEF DESCRIPTION OF THE DRAWINGS

The present invention can be more fully understood by reading the subsequent detailed description and examples with references made to the accompanying drawings, wherein:

FIG. 1 is a schematic view of a power converter of prior art;

FIG. 2 is a schematic view of a power converter according to an embodiment of the present invention;

FIG. 3 is a circuit diagram of a power converter of FIG. 2;

FIG. 4 is a schematic view of an operation of the power converter of FIG. 2 in the first operation period;

FIG. 5 is a schematic view of an operation of the power converter of FIG. 2 in the second operation period;

FIG. 6 is a schematic view of a power converter according to an embodiment of the present invention;

FIG. 7 is a circuit diagram of a power converter of FIG. 6;

FIG. 8A is a schematic view of a wire coupled to a first switch module SR1 in FIG. 7;

FIG. 8B is a schematic view of a wire coupled to a second switch module SR2 in FIG. 7;

FIG. 8C is a schematic view of an internal structure of a first switch module SR1 in FIG. 7;

FIG. 8D is a schematic view of an internal structure of a second switch module SR2 in FIG. 7;

FIG. 8E is a schematic view of an internal structure of a first switch module SR1 and a wire coupled to a first switch module SR1 in FIG. 7;

FIG. 8F a schematic view of an internal structure of a second switch module SR2 and a wire coupled to a second switch module SR2 in FIG. 7;

FIG. 9 is a schematic view of an operation of the power converter of FIG. 7 in the first operation period;

FIG. 10 is a schematic view of an operation of the power converter of FIG. 7 in the second operation period; and

FIG. 11 is a waveform diagram of cross voltages of a first switch module SW1, a second switch module SW2, a third switch module SW3 and a fourth switch module SW4 in FIG. 7.

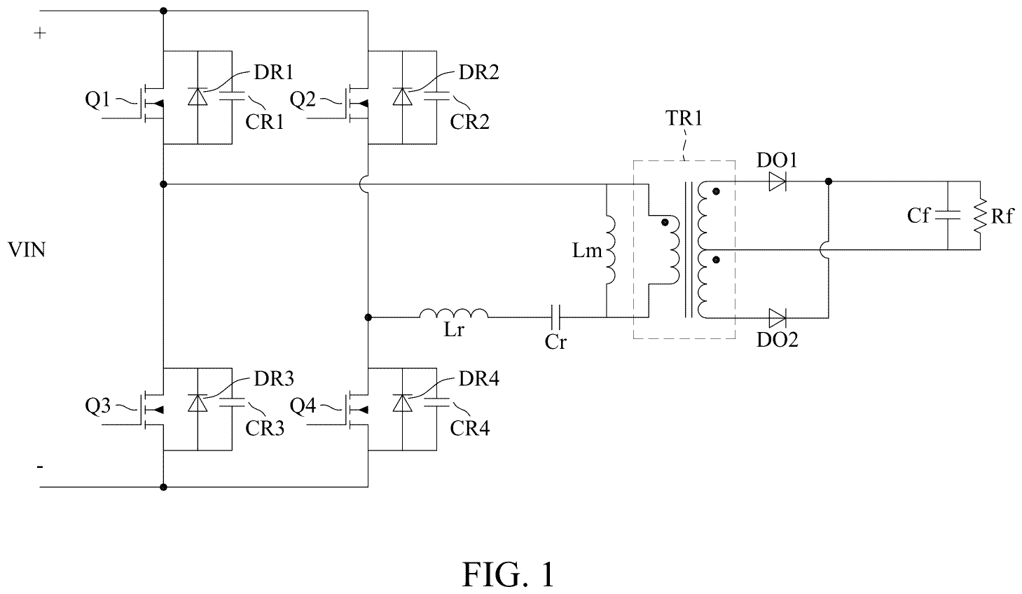

### DETAILED DESCRIPTION OF THE INVENTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, a person skilled in the art would selectively implement all or some technical features of any embodiment of the disclosure or selectively combine all or some technical features of the embodiments of the disclosure.

In each of the following embodiments, the same reference number represents the same or similar element or component.

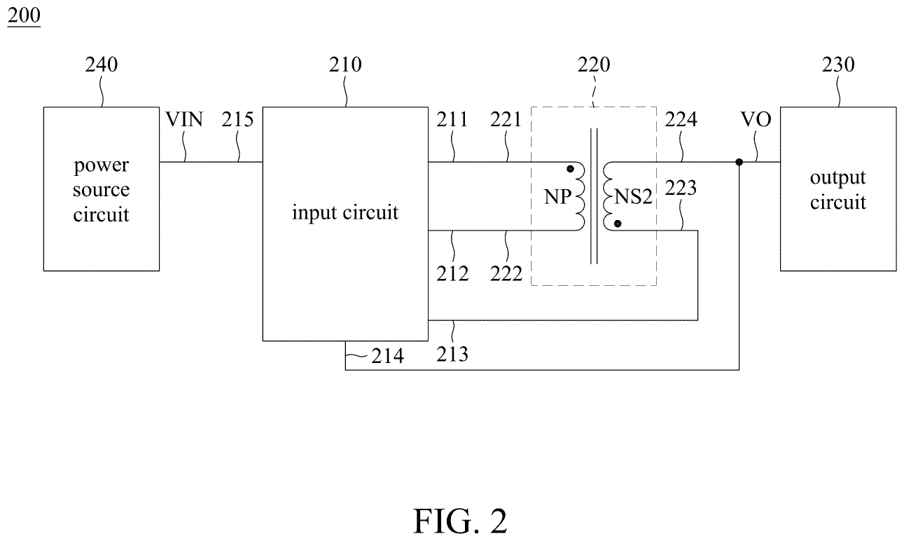

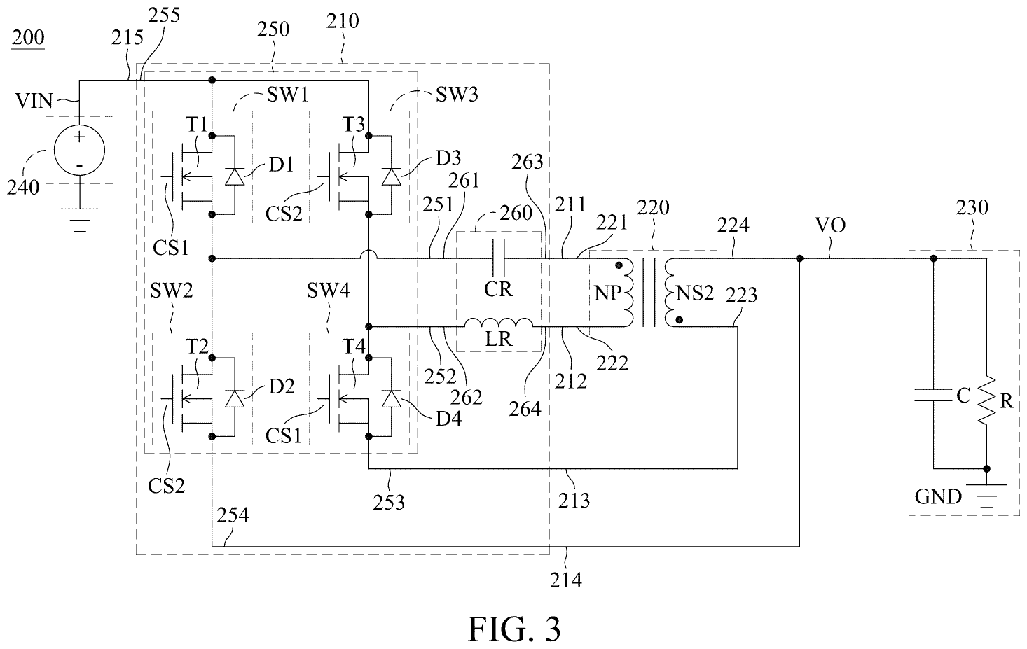

FIG. 2 is a schematic view of a power converter according to an embodiment of the present invention. FIG. 3 is a circuit diagram of a power converter of FIG. 2. In the embodiment, the power converter 200 is an asymmetric power converter. Please refer to FIG. 2 and FIG. 3. The power converter 200 may at least include an input circuit 210, a transformer circuit 220 and an output circuit 230.

The input circuit 210 may have a first contact point 211, a second contact point 212, a third contact point 213 and a fourth contact point 214. The transformer circuit 220 may have a primary winding NP and a first secondary winding NS2. The primary winding NP may have a first contact point 221 and a second contact point 222. The first secondary winding NS2 may have a first contact point 223 and a second contact point 224.

The first contact point 221 of the primary winding NP may be coupled to the first contact point 211 of the input circuit 210. The second contact point 222 of the primary winding NP may be coupled to the second contact point 212 of the input circuit 210. The first contact point 223 of the first secondary winding NS2 may be coupled to the third contact point 213 of the input circuit 210. The second contact point 224 of the first secondary winding NS2 may be coupled to the fourth contact point 214 of the input circuit 210.

The output circuit 230 may be coupled to the second contact point 224 of the first secondary winding NS2. In addition, in some embodiments, the second contact point 224 of the first secondary winding NS2 may generate an output voltage VO.

In some embodiments, the input circuit 210 may further include a fifth contact point 215, and the power converter 200 may further include a power source circuit 240. The power source circuit 240 may be coupled to the fifth contact point 215 of the input circuit 210 and provide an input voltage VIN. As shown in FIG. 3, in some embodiments, the power source circuit 240 may be a voltage source, but the embodiment of the present invention is not limited thereto. It should be noted that the names of the input circuit 210 and the output circuit 230 are used to distinguish different circuits, but are not used to limit the specific function thereof. For example, in FIG. 2, the input circuit 210 is relative to the output circuit 230. The input circuit 210 may periodically change the direction of the current between the input circuit 210 and the transformer circuit 220 through the circuit switching. The input circuit 210 may receive the current from the power source circuit 240 and output the current to the transformer circuit 220, and also receive the current from the transformer circuit 220 and output the current to the output circuit 230 or the transformer circuit 220.

As shown in FIG. 3, in some embodiments, the output circuit 230 may include a capacitor C and a resistor R. The capacitor C may have a first contact point and a second contact point. The first contact point of the capacitor C may be coupled to the second contact point 224 of the first secondary winding NS2. The second contact point of the capacitor C may be coupled to a ground terminal GND. The resistor R may have a first contact point and a second contact point. The first contact point of the resistor R may be coupled to the first contact point of the capacitor C. The second contact point of the resistor R may be coupled to the second contact point of the capacitor C.

As shown in FIG. 3, in some embodiments, the input circuit 210 may include a switch circuit 250 and a resonant circuit 260. The switch circuit 250 may have a first contact point 251, a second contact point 252, a third contact point 253 and a fourth contact point 254. The third contact point 253 of the switch circuit 250 may be coupled to the third contact point 213 of the input circuit 210. The fourth contact point 254 of the switch circuit 250 may be coupled to the fourth contact point 214 of the input circuit 210. In addition, the switch circuit 250 may further include a fifth contact point 255, and the fifth contact point 255 of the switch circuit 250 may be coupled to the fifth contact point 215 of the input circuit 210.

Furthermore, the switch circuit 250 may include a first switch module SW1, a second switch module SW2, a third switch module SW3 and a fourth switch module SW4.

The first switch module SW1 may have a first contact point, a second contact point, and a control contact point. The first contact point of the first switch module SW1 may be coupled to the fifth contact point 255 of the switch circuit 250. The second contact point of the first switch module SW1 may be coupled to the first contact point 251 of the switch circuit 250. The control contact point of the first switch module SW1 may receive a first control signal CS1.

Furthermore, the first switch module SW1 may include a first transistor T1 and a first diode D1. The first transistor T1 may include a first contact point, a second contact point, and a control contact point. The first contact point of the first transistor T1 may be coupled to the first contact point of the first switch module SW1. The second contact point of the first transistor T1 may be coupled to the second contact point of the first switch module SW1. The control contact point of the first transistor T1 may be coupled to the control contact point of the first switch module SW1. The first diode D1 may have a first contact point (such as cathode terminal) and a second contact point (such as an anode terminal). The first contact point of the first diode D1 may be coupled to the first contact point of the first transistor T1. The second contact point of the first diode D1 may be coupled to the second contact point of the first transistor T1.

The second switch module SW2 may have a first contact point, a second contact point, and a control contact point. The first contact point of the second switch module SW2 may be coupled to the second contact point of the first switch module SW1. The second contact point of the second switch module SW2 may be coupled to the fourth contact point 254 of the switch circuit 250. The control contact point of the second switch module SW2 may receive a second control signal CS2.

Furthermore, the second switch module SW2 may include a second transistor T2 and a second diode D2. The second transistor T2 may include a first contact point, a second contact point, and a control contact point. The first contact point of the second transistor T2 may be coupled to the first contact point of the second switch module SW2. The second contact point of the second transistor T2 may be coupled to the second contact point of the second switch module SW2. The control contact point of the second transistor T2 may be coupled to the control contact point of the second switch module SW2. The second diode D2 may have a first contact point (such as cathode terminal) and a second contact point (such as an anode terminal). The first contact point of the second diode D2 may be coupled to the first contact point of the second transistor T2. The second contact point of the second diode D2 may be coupled to the second contact point of the second transistor T2.

The third switch module SW3 may have a first contact point, a second contact point, and a control contact point. The first contact point of the third switch module SW3 may be coupled to the first contact point of the first switch module SW1. The second contact point of the third switch module SW3 may be coupled to the second contact point 252 of the switch circuit 250. The control contact point of the third switch module SW3 may receive the second control signal CS2.

Furthermore, the third switch module SW3 may include a third transistor T3 and a third diode D3. The third transistor T3 may include a first contact point, a second contact point, and a control contact point. The first contact point of the third transistor T3 may be coupled to the first contact point of the third switch module SW3. The second contact point of the third transistor T3 may be coupled to the second contact point of the third switch module SW3. The control contact point of the third transistor T3 may be coupled to the control contact point of the third switch module SW3. The third diode D3 may have a first contact point (such as cathode terminal) and a second contact point (such as an anode terminal). The first contact point of the third diode D3 may be coupled to the first contact point of the third transistor T3. The second contact point of the third diode D3 may be coupled to the second contact point of the third transistor T3.

The fourth switch module SW4 may have a first contact point, a second contact point, and a control contact point. The first contact point of the fourth switch module SW4 may be coupled to the second contact point of the third switch module SW3. The second contact point of the fourth switch module SW4 may be coupled to the third contact point 253 of the third switch module 250. The control contact point of the fourth switch module SW4 may receive the first control signal CS1.

Furthermore, the fourth switch module SW4 may include a fourth transistor T4 and a fourth diode D4. The fourth transistor T4 may include a first contact point, a second contact point, and a control contact point. The first contact point of the fourth transistor T4 may be coupled to the first contact point of the fourth switch module SW4. The second contact point of the fourth transistor T4 may be coupled to the second contact point of the fourth switch module SW4. The control contact point of the fourth transistor T4 may be coupled to the control contact point of the fourth switch module SW4. The fourth diode D4 may have a first contact point (such as cathode terminal) and a second contact point (such as an anode terminal). The first contact point of the fourth diode D4 may be coupled to the first contact point of the fourth transistor T4. The second contact point of the fourth diode D4 may be coupled to the second contact point of the fourth transistor T4.

In some embodiments, each of the first transistor T1˜the fourth transistor T4 may be an N-type transistor (such as MOSFET), wherein the first contact point of each of the first transistor T1˜the fourth transistor T4 may be a drain terminal of the N-type transistor, the second contact point of each of the first transistor T1˜the fourth transistor T4 may be a source terminal of the N-type transistor, and the control contact point of each of the first transistor T1˜the fourth transistor T4 may be a gate terminal of the N-type transistor, but the embodiment of the present invention is not limited thereto. In other embodiments, each of the first transistor T1˜the fourth transistor T4 may be a P-type transistor (such as MOSFET) or another suitable transistor.

In some embodiments, the first control signal CS1 may be different from the second control signal CS2. For example, when the first control signal CS1 is a high voltage level, the second control signal is a low voltage level. When the first control signal CS1 is the low voltage level, the second control signal CS2 is the high voltage level. In addition, when the first control signal CS1 is the high voltage level and the second control signal CS2 is the low voltage level, the first switch module SW1 and the fourth switch module SW4 are turned on, and the second switch module SW2 and the third switch module SW3 are turned off. When the first control signal CS1 is the low voltage level and the second control signal CS2 is the high voltage level, the first switch module SW1 and the fourth switch module SW4 are turned off, and the second switch module SW2 and the third switch module SW3 are turned on. The duty cycle of each of the first control signal CS1 and the second control signal CS2 is equal to or close to 50%.

In the embodiment, the control contacts of the first switch module SW1 and the fourth switch module SW4 receive the same first control signal CS1, but the embodiment of the present invention is not limited thereto. In other embodiments, the first switch module SW1 and the fourth switch module SW4 may receive different control signals, and periods and the duty cycles of the different control signals received by the control contact points of the first switch module SW1 and the fourth switch module SW4 are similar, i.e., the first switch module SW1 and the fourth switch module SW4 may turned on or turned off at the same time.

In addition, in the embodiment, the control contacts of the second switch module SW2 and the third switch module SW3 receive the same second control signal CS2, but the embodiment of the present invention is not limited thereto. In other embodiments, the second switch module SW2 and the third switch module SW3 may receive different control signals, and periods and the duty cycles of the different control signals received by the control contact points of the second switch module SW2 and the third switch module SW3 are similar, i.e., the second switch module SW2 and the third switch module SW3 may turned on or turned off at the same time.

The resonant circuit 260 may have a first contact point 261, a second contact point 262, a third contact point 263 and a fourth contact point 264. The first contact point 261 of the resonant circuit 260 may be coupled to the first contact point 251 of the switch circuit 250. The second contact point 262 of the resonant circuit 260 may be coupled to the second contact point 252 of the switch circuit 250. The third contact point 263 of the resonant circuit 260 may be coupled to the first contact point 211 of the input circuit 210 and the first contact point 221 of the primary winding NP. The fourth contact point 264 of the resonant circuit 260 may be coupled to the second contact point 212 of the input circuit 210 and the second contact point 222 of the primary winding NP.

Furthermore, the resonant circuit 260 may include a resonant capacitor CR and a resonant inductor LR. The resonant capacitor CR may have a first contact point and a second contact point. The first contact point of the resonant capacitor CR may be coupled to the first contact point 261 of the resonant circuit 260. The second contact point of the resonant capacitor CR may be coupled to the third contact point 263 of the resonant circuit 260.

The resonant inductor LR may have a first contact point and a second contact point. The first contact point of the resonant inductor LR may be coupled to the second contact point 262 of the resonant circuit 260. The second contact point of the resonant inductor LR may be coupled to the fourth contact point 264 of the resonant circuit 260. In the embodiment, the resonant circuit 260 has a resonant frequency, and the resonant frequency of the resonant circuit 260 is, for example, similar to or equal to the switching frequency of the switch circuit 250.

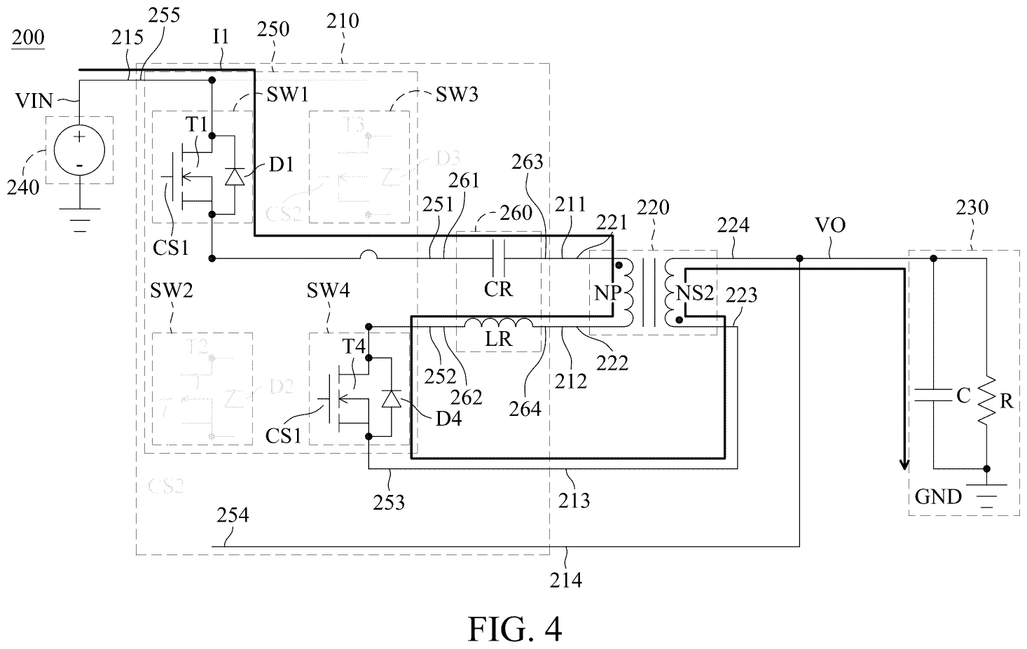

In the entire operation of the power converter 200, in the first operation period of the power converter 200, the first current I1 may flow through the first contact point 211 of the input circuit 210, the first contact point 221 of the primary winding NP, the second contact point 222 of the primary winding NP, the second contact point 212 of the input circuit 210, the third contact point 213 of the input circuit 210, the first contact point 223 of the first secondary winding NS2, the second contact point 224 of the first secondary winding NS2 and the output circuit 230, as shown in FIG. 4. In addition, in the first operation period of the power converter 200, the first control signal CS1 is the high voltage level, the second control signal CS2 is the low voltage level, the first switch module SW1 and the fourth switch module SW4 are turned on, and the second switch module SW2 and the fourth switch module SW3 are turned off.

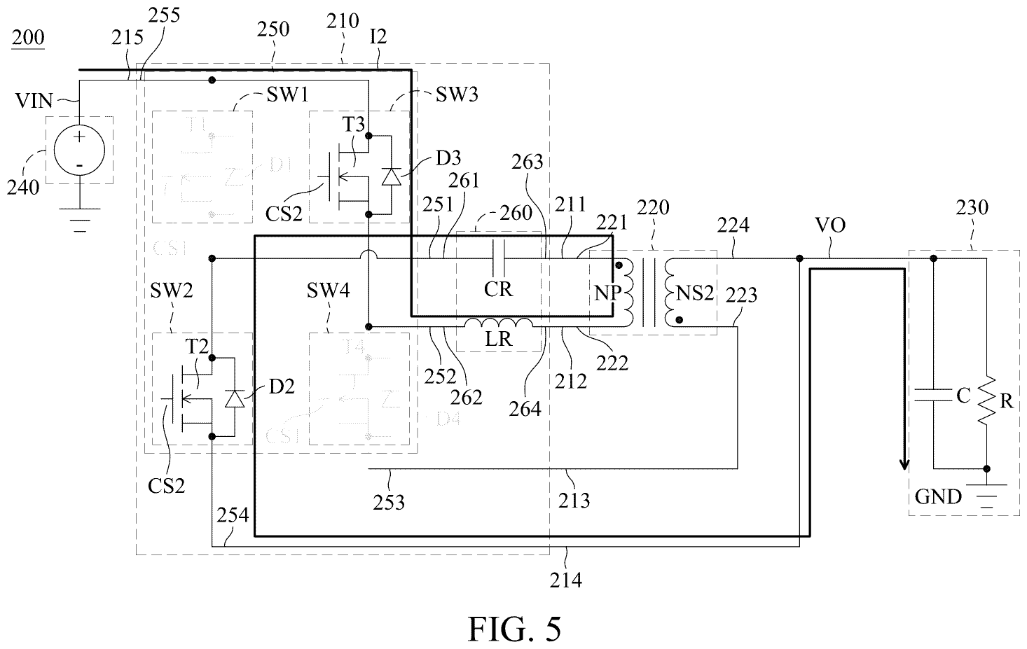

Then, in the second operation period of the power converter 200, the second current I2 may flow through the second contact point 212 of the input circuit 210, the second contact point 222 of the primary winding NP, the first contact point 221 of the primary winding NP, the first contact point 211 of the input circuit 210, the fourth contact point 214 of the input circuit 210 and the output circuit 230, as shown in FIG. 5. In addition, in the second operation period of the power converter 200, the first control signal CS1 is the low voltage level, the second control signal CS2 is the high voltage level, the first switch module SW1 and the fourth switch module SW4 are turned off, and the second switch module SW2 and the third switch module SW3 are turned on.

In addition, in the embodiment, as shown in FIG. 3, the resonant circuit 260 is disposed in the input circuit 210, but the embodiment of the present invention is not limited thereto. In other embodiments, the resonant circuit 260 may also not be disposed in the input circuit 210. For example, the resonant circuit 260 may be independently disposed outside the input circuit 210 or before the output circuit 230, and the same technical effect may be achieved. Furthermore, in FIG. 3, the resonant circuit 260 includes the resonant capacitor CR and the resonant inductor LR, which is an exemplary embodiment of the embodiment of the present invention, but is not intended to limit the circuit structure of the resonant circuit 260.

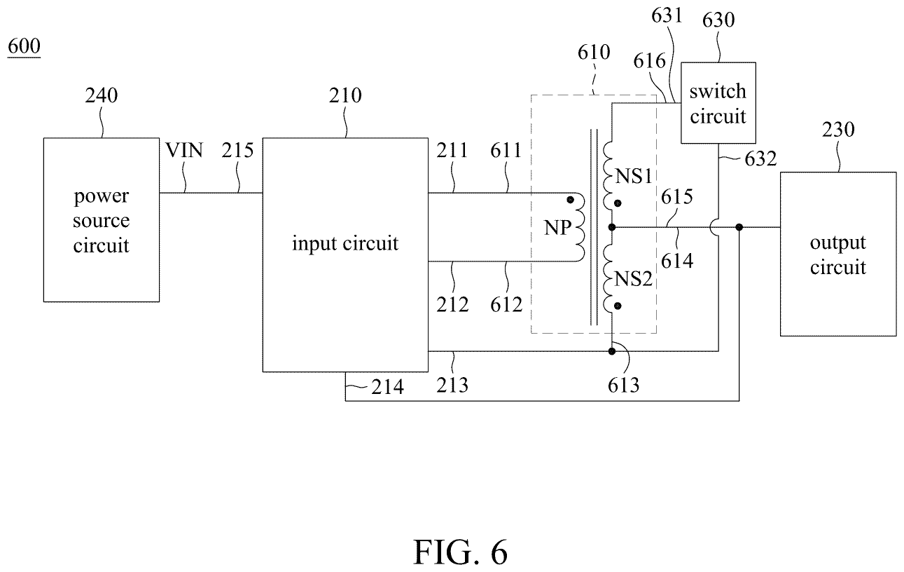

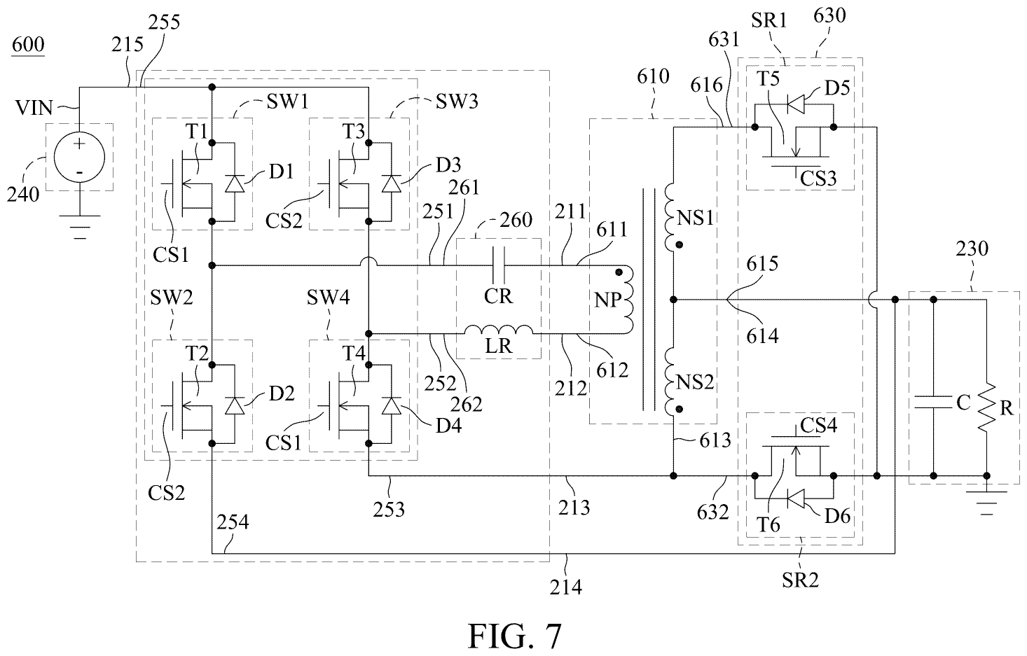

FIG. 6 is a schematic view of a power converter according to an embodiment of the present invention. FIG. 7 is a circuit diagram of a power converter of FIG. 6. In the embodiment, the power converter 600 may be an asymmetric power resonant converter. Please refer to FIG. 6 and FIG. 7. The power converter 600 may include an input circuit 210, a transformer circuit 610, an output circuit 230, a power source circuit 240 and a switch circuit 630. In the embodiment, the input circuit 210, the output circuit 230, the power circuit 240 and their internal components and coupling relationships of FIG. 6 and FIG. 7 are the same as or similar to the input circuit 210, the output circuit 230, the power circuit 240 and their internal components and coupling relationships of FIG. 2 and FIG. 3. Accordingly, the input circuit 210, the output circuit 230, the power circuit 240 and their internal components and coupling relationships of FIG. 6 and FIG. 7 may refer to the description of the embodiments of FIG. 2 and FIG. 3, and the description thereof is not repeated herein.

The transformer circuit 610 may include a primary winding NP, a first secondary winding NS2 and a second secondary winding NS1. The primary winding NP may have a first contact point 611 and a second contact point 612. The first secondary winding NS2 may have a first contact point 613 and a second contact point 614. The second secondary winding NS1 may have a first contact point 615 and a second contact point 616.

The first contact point 611 of the primary winding NP may be coupled to the first contact point 211 of the input circuit 210. The second contact point 612 of the primary winding NP may be coupled to the second contact point 212 of the input circuit 210. The first contact point 613 of the first secondary winding NS2 may be coupled to the third contact point 213 of the input circuit 210. The second contact point 614 of the first secondary winding NS2 may be coupled to the fourth contact point 214 of the input circuit 210 and the output circuit 230. The first contact point 615 of the second secondary winding NS1 may be coupled to the second contact point 614 of the first secondary winding NS2.

In some embodiments, the number of turns in the primary winding NP may be different from the number of turns in the first secondary winding NS2 and the number of turns in the second secondary winding NS1, and the number of turns in the first secondary winding NS2 may the same as the number of turns in the second secondary winding NS1. Furthermore, the number of turns in the primary winding NP may be greater than the number of turns in the first secondary winding NS2 and the number of turns in the second secondary winding NS1. For example, the turns ratio of the primary winding NP, the first secondary winding NS2 and the second secondary NS1 may be 2:1:1, or 3:1:1, but the embodiment of the present invention is not limited thereto.

The switch circuit 630 may have a first contact point 631 and a second contact point 632. The first contact point 631 of the switch circuit 630 may be coupled to the second contact point 616 of the second secondary winding NS1. The second contact point 632 of the switch circuit 630 may be coupled to the first contact point 613 of the first secondary winding NS2.

Furthermore, the switch circuit 630 may include a first switch module SR1 and a second switch module SR2. The first switch module SR1 may have a first contact point, a second contact point, and a control contact point. The first contact point of the first switch module SR1 may be coupled to the first contact point 631 of the switch circuit 630. The second contact point of the first switch module SR1 may be coupled to a ground terminal GND. The control contact point of the first switch module SR1 may receive a first control signal CS3.

Furthermore, the first switch module SR1 may include a fifth transistor T5 and a fifth diode D5. The fifth transistor T5 may include a first contact point, a second contact point, and a control contact point. The first contact point of the fifth transistor T5 may be coupled to the first contact point of the first switch module SR1. The second contact point of the fifth transistor T5 may be coupled to the second contact point of the first switch module SR1. The control contact point of the fifth transistor T5 may be coupled to the control contact point of the first switch module SR1. The fifth diode D5 may have a first contact point (such as a cathode terminal) and a second contact point (such as an anode terminal). The first contact point of the fifth diode D5 may be coupled to the first contact point of the fifth transistor T5. The second contact point of the fifth diode D5 may be coupled to the second contact point of the fifth transistor T5.

The second switch module SR2 may have a first contact point, a second contact point, and a control contact point. The first contact point of the second switch module SR2 may be coupled to the second contact point 632 of the switch circuit 630. The second contact point of the second switch module SR2 may be coupled to the second contact point of the first switch module SR1. The control contact point of the second switch module SR2 may receive a second control signal CS4.

Furthermore, the second switch module SR2 may include a sixth transistor T6 and a sixth diode D6. The sixth transistor T6 may have a first contact point, a second contact point, and a control contact point. The first contact point of the sixth transistor T6 may be coupled to the first contact point of the second switch module SR2. The second contact point of the sixth transistor T6 may be coupled to the second contact point of the second switch module SR2. The control contact point of the sixth transistor T6 may be coupled to the control contact point of the second switch module SR2. The sixth diode D6 may have a first contact point (such as a cathode terminal) and a second contact point (such as an anode terminal). The first contact point of the sixth diode D6 may be coupled to the first contact point of the sixth transistor T6. The second contact point of the sixth diode D6 may be coupled to the second contact point of the sixth transistor T6.

In some embodiments, each of the fifth transistor T5 and the sixth transistor T6 may be a N-type transistor (such as MOSFET), wherein the first contact point of each of the fifth transistor T5 and the sixth transistor T6 may be a drain terminal of the N-type transistor, the second contact point of each of the fifth transistor T5 and the sixth transistor T6 may be a source terminal of the N-type transistor, and the control contact point of each of the fifth transistor T5 and the sixth transistor T6 may be a N-type transistor, but the embodiment of the present invention is not limited thereto. In some embodiments, each of the fifth transistor T5 and the sixth transistor T6 may be a P-type transistor (such as MOSFET) or another suitable transistor.

In some embodiments, the first control signal CS3 may be different from the second control signal CS4. In some embodiments, the first control signal CS3 may be different from the first control signal CS1. For example, in some embodiments, when the control contact points of the first switch module SW1 and the fourth switch module SW4 receive the same first control signal CS1, the period of the first control signal CS3 may correspond to the period of the first control signal CS1, and the duty cycle of the first control signal CS3 is smaller than the duty cycle of the first control signal CS1.

In another embodiment, when the control contact points of the first switch module SW1 and the fourth switch module SW4 receive the different control signals, the period of the first control signal CS3 may correspond to the period of the control signal received by the control contact point of the first switch module SW1 or the fourth switch module SW4, and the duty cycle of the first control signal CS3 is smaller than the duty cycle of the control signal received by the control contact point of the first switch module SW1 or the fourth switch module SW4.

In some embodiments, the second control signal CS4 may be different from the second control signal CS2. For example, in some embodiments, when the control contact points of the second switch module SW2 and the third switch module SW3 receive the same second control signal CS2, the period of the second control signal CS4 may correspond to the period of the second control signal CS2, and the duty cycle of the second control signal CS4 is smaller than the duty cycle of the second control signal CS2.

In another embodiment, when the control contact points of the second switch module SW2 and the third switch module SW3 receive the different control signals, the period of the second control signal CS4 may correspond to the period of the control signal received by the control contact point of the second switch module SW2 or the third switch module SW3, and the duty cycle of the second control signal CS4 is smaller than the duty cycle of the control signal received by the control contact point of the second switch module SW2 or the third switch module SW3.

For example, when the first control signal CS1 and the first control signal CS3 are high voltage levels, the second control signal CS2 and the second control signal CS4 are the low voltage levels. When the first control signal CS1 and the first control signal CS3 are the low voltage levels, the second control signal CS2 and the second control signal CS4 are the high voltage levels.

In addition, when the first control signal CS1 and the first control signal CS3 are the high voltage levels and the second control signal CS2 and the second control signal CS4 are the low voltage levels, the first switch module SW1, the fourth switch module SW4 and the first switch module SR1 are turned on, and the second switch module SW2, the third switch module SW3 and the second switch module SR2 are turned off. When the first control signal CS1 and the first control signal CS3 are the low voltage levels and the second control signal CS2 and the second control signal CS4 are the high voltage levels, the first switch module SW1, the fourth switch module SW4 and the first switch module SR1 are turned off, and the second switch module SW2, the third switch module SW3 and the second switch module SR2 are turned on.

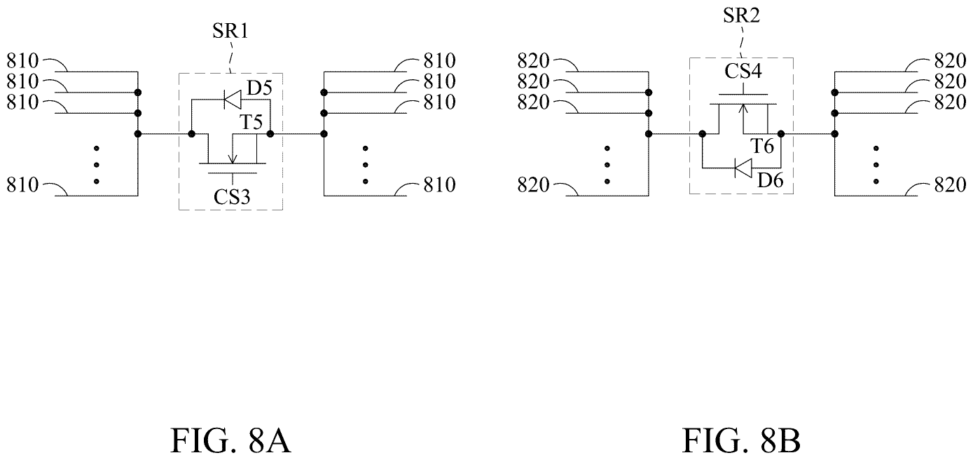

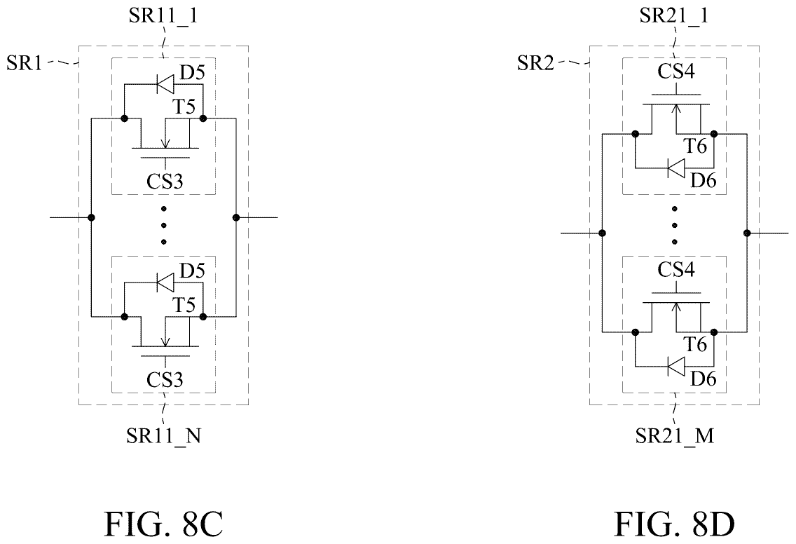

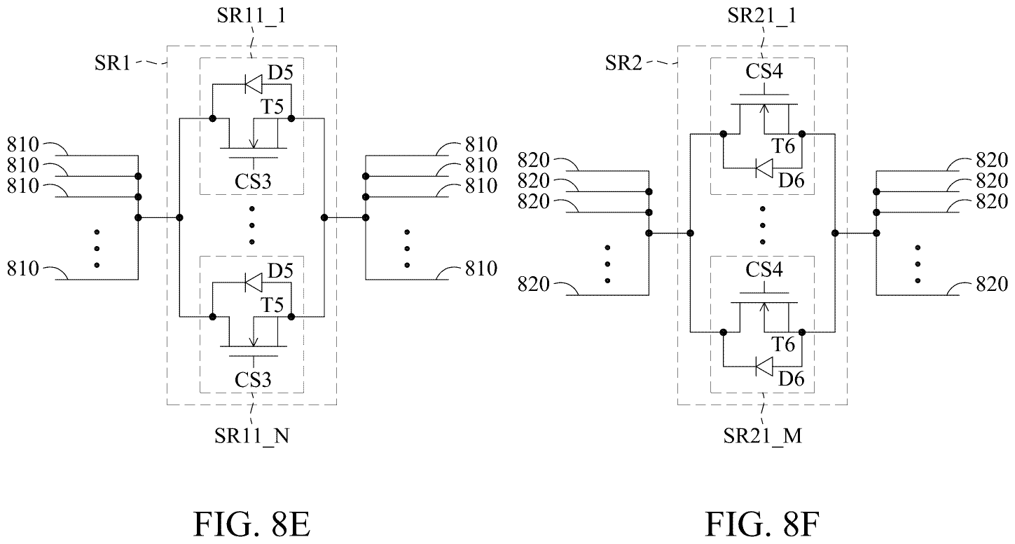

In some embodiments, as shown in FIG. 8A, a wire coupled to the first switch module SR1 may be formed by connecting wires of a plurality of first circuit boards 810 in parallel. In addition, as shown in FIG. 8B, wire coupled to the second switch module SR2 may be formed by connecting wires of a plurality of second circuit boards 820 in parallel. In some embodiments, the number of first circuit boards 810 as shown in FIG. 8A may be greater than the number of second circuit boards 820 as shown in FIG. 8B, but the embodiment of the present invention is not limited thereto. In addition, the above second circuit board 820 may be partially identical to the first circuit board 810, i.e., they may share the same circuit board, as long as the wire positions are different.

In some embodiments, as shown in FIG. 8C, the first switch module SR1 may include a plurality of first switch units SR11_1˜SR11_N, and the first switch units SR11_1˜SR11_N are coupled in parallel, wherein N is a positive integer greater than 1. In addition, each of the first switch units SR11_1˜SR11_N may include a fifth transistor T5 and a fifth diode D5. In some embodiments, as shown in FIG. 8D, the second switch module SR2 may include a plurality of second switch units SR21_1˜SR21_M, and the second switch units SR21_1˜SR21_M are coupled in parallel, wherein M is a positive integer greater than 1. In addition, each of the second switch units SR21_1˜SR21_M may include a sixth transistor T6 and a sixth diode D6. In some embodiments, the number of first switch units SR11_1˜SR11_N as shown in FIG. 8C is, for example, greater than the number of second switch units SR21_1˜SR21_M as shown in FIG. 8D, i.e., N is greater than M.

In addition, as shown in FIG. 8E, the first switch module SR1 may include a plurality of first switch units SR11_1˜SR11_N, the first switch units SR11_1˜SR11_N are coupled in parallel, and a wire coupled to the first switch module SR1 may be formed by connecting wires of a plurality of first circuit boards 810 in parallel. In other embodiments, the first circuit boards 810 may also connected in parallel and then connected in series to each of the first switch units SR11_1˜SR11_N, so as to withstand a larger current.

Furthermore, in some embodiments, as shown in FIG. 8F, the second switch module SR2 may include a plurality of second switch units SR21_1˜SR21_M, the second switch units SR21_1˜SR21_M N are coupled in parallel, and a wire coupled to the second switch module SR2 may be formed by connecting wires of a plurality of second circuit boards 820 in parallel. In other embodiments, the second circuit boards 820 may also connected in parallel and then connected in series to each of the second switch units SR21_1˜SR21_M, so as to withstand a larger current. In addition, the number of first switch units SR11_1˜SR11_N as shown in FIG. 8E is, for example, greater than the number of second switch units SR21_1˜SR21_M as shown in FIG. 8F, and the number of first circuit boards 810 as shown in FIG. 8E is, for example, greater than the number of second circuit boards 820 as shown in FIG. 8F, so as to withstand a larger current.

In some embodiments, the voltage conversion ratio of the power converter 600 may be expressed by the following formula:

$$VTR = \frac{2}{2 + \frac{N P + NS 2}{NS 1} + \frac{N P}{NS 2}} ,$$

wherein VTR is the voltage conversion ratio, NP is the number of turns in the primary winding NP, NS1 is the number of turns in the second secondary winding NS1, and NS2 is the number of turns in the first secondary winding NS2.

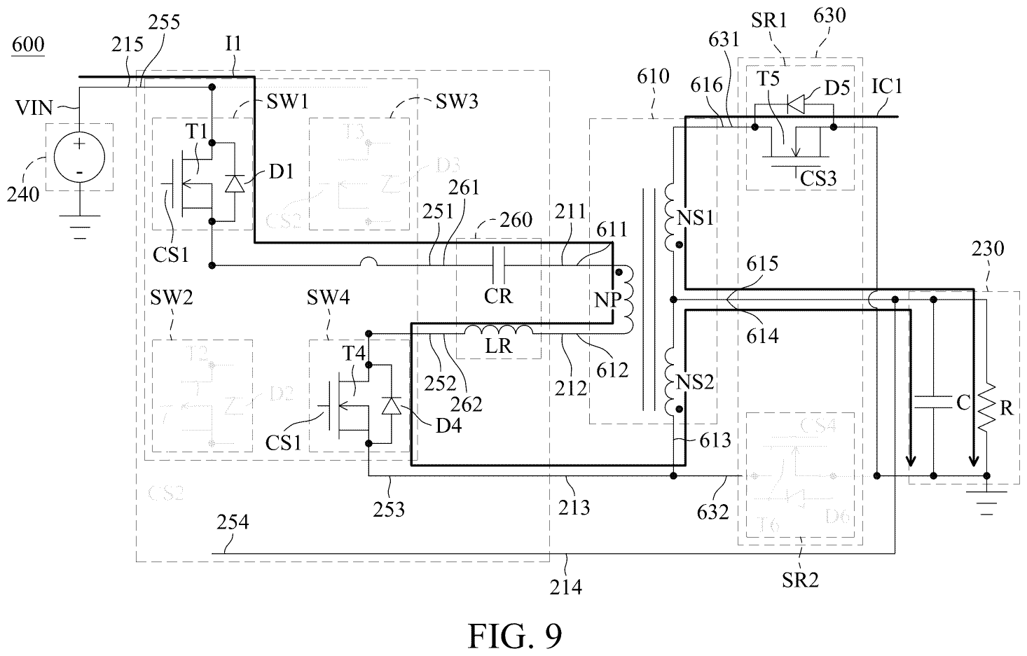

In the first operation period of the power converter 600, a first current I1 may flow through the first contact point 211 of the input circuit 210, the first contact point 611 of the primary winding NP, the second contact point 612 of the primary winding NP, the second contact point 212 of the input circuit 210, the third contact point 213 of the input circuit 210, the first contact point 613 of the first secondary winding NS2, the second contact point 614 of the first secondary winding NS2 and the output circuit 230, and a first induced current IC1 may flow through the first contact point 631 of the switch circuit 630, the second contact point 616 of the second secondary winding NS1, the second contact point 614 of the first secondary winding NS2 (the first contact point 615 of the second secondary winding NS1) and the output circuit 230, as shown in FIG. 9.

In the first operation period of the power converter 600, the first control signal CS1 is the high voltage level, the second control signal CS2 is the low voltage level, the first switch module SW1, the fourth switch module SW4 and the first switch module SR1 are turned on, and the second switch module SW2, the third switch module SW3 and the second switch module SR2 are turned off.

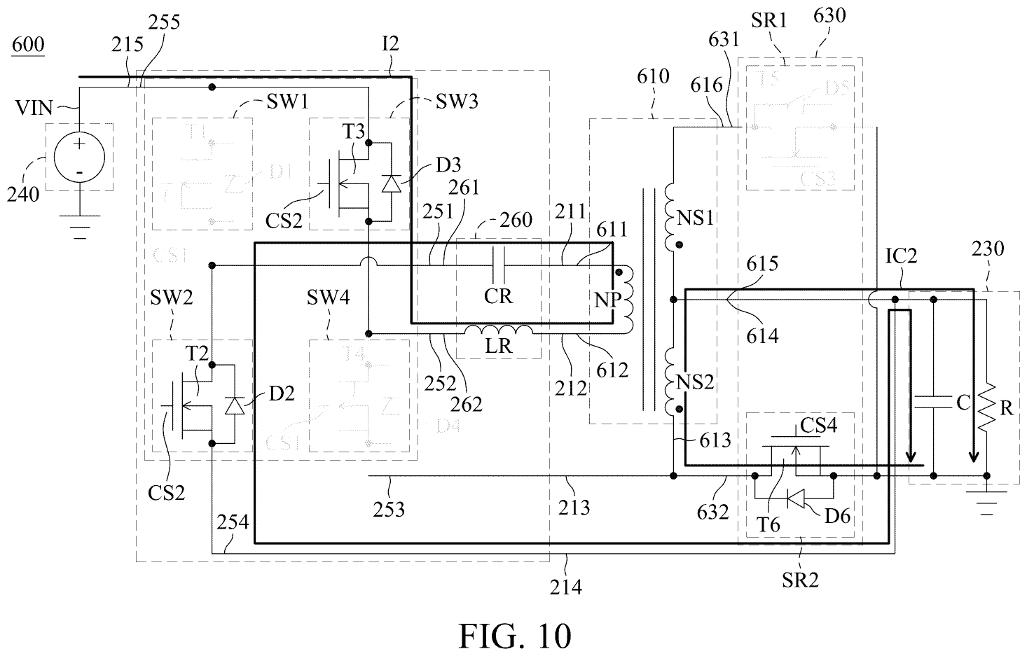

Then, in the second operation period of the power converter 600, a second current I2 may flow through the second contact point 212 of the input circuit 210, the second contact point 612 of the primary winding NP, the first contact point 611 of the primary winding NP, the first contact point 211 of the input circuit 210, the fourth contact point 214 of the input circuit 210 and the output circuit 230, and a second inducted current IC2 may flow through the second contact point 632 of the switch module 630, the first contact point 613 of the first secondary winding NS2, the second contact point 614 of the first secondary winding NS2 and the output circuit 230, as shown in FIG. 10.

In addition, in the second operation period of the power converter 600, the first control signal CS1 is the low voltage level, the second control signal CS2 is the high voltage level, the first switch module SW1, the fourth switch module SW4 and the first switch module SR1 are turned off, and the second switch module SW2, the third switch module SW3 and the second switch module SR2. Furthermore, in the embodiment, the first induced current IC1 is, for example, greater than the second induced current IC2.

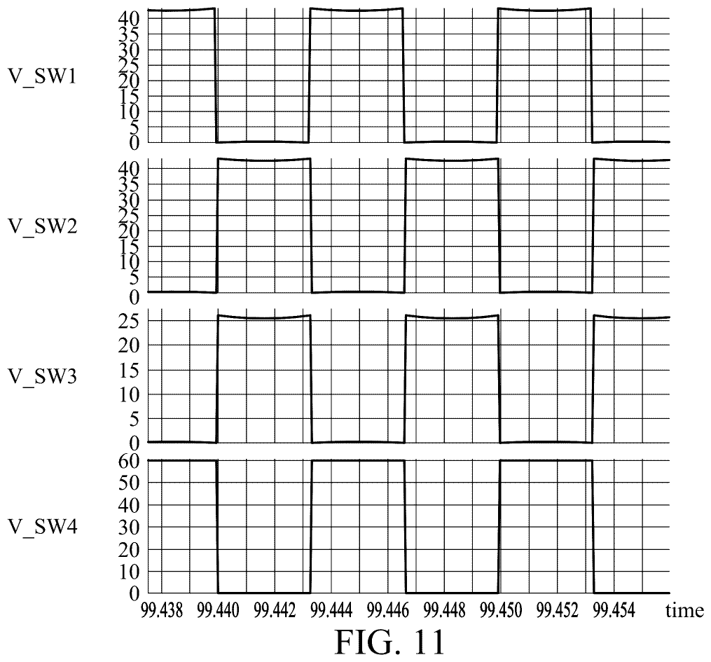

As can be seen from FIG. 11, when the input voltage VIN is 60V, the cross voltage V_SW1 of the first switch module SW1 is about 42V, the cross voltage V_SW2 of the second switch module SW2 is about 42V, the cross voltage V_SW3 of the third switch module SW3 is about 25V, and the cross voltage V_SW4 of the fourth switch module SW4 is about 60V. Therefore, the switch withstand voltage and switch cost of the input circuit 210 (such as the first switch module SW1, the second switch module SW2 and the third switch module SW3) may be effectively reduced, and the circuit loss may be reduced and the circuit conversion efficiency may be increased, so as to save energy.

In addition, it can be seen for Table 1 that, compared with the conventional power converter 100, the power converter 600 of the embodiment of the present invention may have a lower turns ratio (i.e., the turns ratio of the primary winding NP, the first secondary winding NS2 and the second secondary winding NS1) and a higher power conversion ratio. For example, the power converter 600 has the turns ratio of 3:1:1 and the voltage conversion ratio of 4.5. Therefore, the power converter 600 of the embodiment may improve the voltage conversion ratio while reducing the number of turns required for the winding of the transformer circuit 610 and the corresponding copper wire loss.

TABLE 1

| | voltage | | input | |
|---|---|---|---|---|
| | conversion | turns | voltage | output |
| structure | ratio | ratio | VIN | voltage |
| the power converter 100 | 4 | 4:1:1 | 40~60 V | 10~15 |
| of prior art | | | | |
| the power converter 600 | 3.5 | 2:1:1 | 40~60 V | 11.4~17 |
| of the embodiment of the | | | | |
| present invention | | | | |
| the power converter 600 | 4.5 | 3:1:1 | 40~60 V | 8.84~13.3 |
| of the embodiment of the | | | | |
| present invention | | | | |

In summary, according to the power converter disclosed by the embodiment of the present invention, the first contact point of the primary winding of the transformer circuit is coupled to the first contact point of the input circuit, the second contact point of the primary winding of the transformer circuit is coupled to the second contact point of the input circuit, the first contact point of the first secondary winding of the transformer circuit is coupled to the third contact point of the input circuit, and the second contact point of the first secondary winding of the transformer circuit is coupled to the fourth contact point of the input circuit. The output circuit is coupled to the second contact point of the first secondary winding. Therefore, the switch withstand voltage and switch cost of the input circuit may be effectively reduced, and the circuit loss may be reduced and the circuit conversion efficiency may be increased, so as to save energy.

In addition, the transformer circuit of the embodiment further includes the second secondary winding, the first contact point of the second secondary winding is coupled to the second contact point of the first secondary winding, and the power converter further includes the switch module, the first contact point of the switch module is coupled to the second contact point of the second secondary winding, and the second contact point of the switch module is coupled to the first contact point of the first secondary winding. Therefore, the power converter may improve the voltage conversion ratio while reducing the number of turns required for the winding of the transformer circuit and the corresponding copper wire loss.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power converter, comprising:
an input circuit, having a first contact point, a second contact point, a third contact point, and a fourth contact point;
a transformer circuit, having a primary winding and a first secondary winding, wherein the primary winding has a first contact point and a second contact point, the first secondary winding has a first contact point and a second contact point, the first contact point of the primary winding is coupled to the first contact point of the input circuit, the second contact point of the primary winding is coupled to the second contact point of the input circuit, the first contact point of the first secondary winding is coupled to the third contact point of the input circuit, and the second contact point of the first secondary winding is coupled to the fourth contact point of the input circuit; and
an output circuit, coupled to the second contact point of the first secondary winding.

2. The power converter as claimed in claim 1, wherein the second contact point of the first secondary winding is configured to generate an output voltage.

3. The power converter as claimed in claim 1, wherein the transformer circuit further comprises:
a second secondary winding, having a first contact point and a second contact point, wherein the first contact point of the second secondary winding is coupled to the second contact point of the first secondary winding.

4. The power converter as claimed in claim 3, wherein a number of turns in the primary winding is different from a number of turns in the first secondary winding and a number of turns in the second secondary winding, and the number of turns in the first secondary winding is the same as the number of turns in the second secondary winding.

5. The power converter as claimed in claim 4, wherein the number of turns in the primary winding is greater than the number of turns in the first secondary winding and the number of turns in the second secondary winding.

6. The power converter as claimed in claim 3, further comprising:
a switch circuit, having a first contact point and a second contact point, wherein the first contact point of the switch circuit is coupled to the second contact point of the second secondary winding, and the second contact point of the switch circuit is coupled to the first contact point of the first secondary winding.

7. The power converter as claimed in claim 6, wherein the switch circuit comprises:
a first switch module, having a first contact point, a second contact point, and a control contact point, wherein the first contact point of the first switch module is coupled to the first contact point of the switch circuit, the second contact point of the first switch module is coupled to a ground terminal, and the control contact point of the first switch module is configured to receive a first control signal; and
a second switch module, having a first contact point, a second contact point, and a control contact point, wherein the first contact point of the second switch module is coupled to the second contact point of the switch circuit, the second contact point of the second switch module is coupled to the second contact point of the first switch module, and the control contact point of the second switch module is configured to receive a second control signal.

8. The power converter claimed in claim 7, wherein the first control signal is different from the second control signal.

9. The power converter as claimed in claim 7, wherein a wire coupled to the first switch module is formed by connecting wires of a plurality of first circuit boards in parallel, a wire coupled to the second switch module is formed by connecting wires of a plurality of second circuit boards in parallel.

10. The power converter in claim 9, wherein a number of the plurality of first circuit boards is greater than a number of the plurality of second circuit boards.

11. The power converter as claimed in claim 7, wherein the first switch module comprises a plurality of first switch units, and the plurality of first switch units are coupled in parallel;
wherein the second switch module comprises a plurality of second switch units, and the plurality of second switch units are coupled in parallel.

12. The power converter as claimed in claim 11, wherein a number of the plurality of first switch units is greater than a number of the plurality of second switch units.

13. The power converter as claimed in claim 11, wherein a wire coupled to the first switch module is formed by connecting wires of a plurality of first circuit boards in parallel, and a wire coupled to the second switch module is formed by connecting wires of a plurality of second circuit boards in parallel.

14. The power converter as claimed in claim 13, wherein a number of the plurality of first circuit boards is greater than a number of the plurality of second circuit boards.

15. The power converter as claimed in claim 3, wherein a voltage conversion ratio of the power converter is expressed by the following formula:
$$VTR = \frac{2}{2 + \frac{N P + NS 2}{NS 1} + \frac{N P}{NS 2}} ,$$
wherein VTR is the voltage conversion ratio, NP is a number of turns in the primary winding, NS2 is a number of turns in the first secondary winding, and NS1 is a number of turns in the second secondary winding.

16. The power converter as claimed in claim 1, wherein the input circuit further comprises a fifth contact point, and the power converter further comprises:
a power source circuit, coupled to the fifth contact point, and configured to provide an input voltage.

17. The power converter as claimed in claim 1, wherein the output circuit comprises:
a capacitor, having a first contact point and a second contact point, wherein the first contact point of the capacitor is coupled to the second contact point of the first secondary winding, and the second contact point of the capacitor is coupled to a ground terminal; and
a resistor, having a first contact point and a second contact point, wherein the first contact point of the resistor is coupled to the first contact point of the capacitor, and the second contact point of the resistor is coupled to the second contact point of the capacitor.

18. The power converter as claimed in claim 1, wherein the input circuit comprises:
a switch circuit, having a first contact point, a second contact point, a third contact point, and a fourth contact point, wherein the third contact point of the switch circuit is coupled to the third contact point of the input circuit, and the fourth contact point of the switch circuit is coupled to the fourth contact point of the input circuit; and
a resonant circuit, having a first contact point, a second contact point, a third contact point, and a fourth contact point, wherein the first contact point of the resonant circuit is coupled to the first contact point of the switch circuit, the second contact point of the resonant circuit is coupled to the second contact point of the switch circuit, the third contact point of the resonant circuit is coupled to the first contact point of the primary winding, and the fourth contact point of the resonant circuit is coupled to the second contact point of the primary winding.

19. The power converter as claimed in claim 18, wherein the switch circuit comprises:
a first switch module, having a first contact point, a second contact point, and a control contact point, wherein the second contact point of the first switch module is coupled to the first contact point of the switch circuit, and the control contact point of the first switch module is configured to receive a first control signal;
a second switch module, having a first contact point, a second contact point, and a control contact point, wherein the first contact point of the second switch module is coupled to the second contact point of the first switch module, the second contact point of the second switch module is coupled to the fourth contact point of the switch circuit, and the control contact point of the second switch module is configured to receive a second control signal;
a third switch module, having a first contact point, a second contact point, and a control contact point, wherein the first contact point of the third switch module is coupled to the first contact point of the first switch module, the second contact point of the third switch module is coupled to the second contact point of the switch circuit, and the control contact point of the third switch module is configured to receive the second control signal; and
a fourth switch module, having a first contact point, a second contact point, and a control contact point, wherein the first contact point of the fourth switch module is coupled to the second contact point of the third switch module, the second contact point of the fourth switch module is coupled to the third contact point of the third switch module, and the control contact point of the fourth switch module is configured to receive the first control signal.

20. The power converter as claimed in claim 19, wherein the first control signal is different from the second control signal.

21. The power converter as claimed in claim 18, wherein the resonant circuit comprises:
a resonant capacitor, having a first contact point and a second contact point, wherein the first contact point of the resonant capacitor is coupled to the first contact point of the resonant circuit, and the second contact point of the resonant capacitor is coupled to the third contact point of the resonant circuit; and
a resonant inductor, having a first contact point and a second contact point, wherein the first contact point of the resonant inductor is coupled to the second contact point of the resonant circuit, and the second contact point of the resonant inductor is coupled to the fourth contact point of the resonant circuit.

22. The power converter as claimed in claim 1, wherein in a first operation period of the power converter, a first current flows through the first contact point of the input circuit, the first contact point of the primary winding, the second contact point of the primary winding, the second contact point of the input circuit, the third contact point of the input circuit, the first contact point of the first secondary winding, the second contact point of the first secondary winding and the output circuit.

23. The power converter as claimed in claim 22, wherein in a second operation period of the power converter, a second current flows through the second contact point of the input circuit, the second contact point of the primary winding, the first contact point of the primary winding, the first contact point of the input circuit, the fourth contact point of the input circuit and the output circuit.
